(19) United States
(12) Patent Application Publication
(10) Pub. No.: US 2008/0273078 A1
(43) Pub. Date: Nov. 6, 2008

(54) Videoconferencing audio distribution

(76) Inventors: Scott Grasley, Corvallis, OR (US); Mark E. Gorzynski, Corvallis, OR (US); David R. Ingalls, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/799,129

(22) Filed: May 1, 2007

(51) Int. Cl. H04N 7/14

(52) U.S. Cl. 348/14.08; 348/E07.083

(57) ABSTRACT

Systems, methodologies, and media associated with videoconferencing are described. One example system includes video display devices and audio output devices to output video and related audio received from a remote videoconferencing location(s). The example system includes a distribution logic to selectively route audio data to an audio output device(s) and to selectively route video data to a video display device(s). The routing may be based, at least in part, on a relationship between an audio source and a video source. The result of the routing is to cause audio outputs to be acoustically associated with related video outputs so that different audio and video outputs will be spatially distinguishable and so that audio is attributable to related video.

### BACKGROUND

A videoconference may involve two locations, a remote location and a local location. In this case, audio from the remote location may be the only audio that needs to presented at the local location, and vice versa. However, a videoconference may involve more than two locations (e.g., one local location, two remote locations). In this case, two separate video feeds may be available. These two video feeds may be displayed on a single display using, for example, a “split-screen” or they may be displayed on multiple screens. There may also be two separate audio feeds. Conventionally, the two separate audio feeds would be broadcast from a single output device or a stereo output device system associated with the single display. Typically the audio would appear to come from the video display but would not be attributable to either portion of the split screen or to any of multiple screens. Thus, all remote participants may appear to be speaking from the same location, which may make it difficult to understand who is speaking and to distinguish between output from multiple locations.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some cases one element may be designed as multiple elements or that multiple elements may be designed as one element. In some cases, an element shown as an internal component of another element may be implemented as an external component and vice versa. Furthermore, elements may not be drawn to scale.

FIG. 1 illustrates a portion of one embodiment of a system supporting a videoconference session involving two locations.

FIG. 2 illustrates a portion of one embodiment of a system supporting a videoconference session involving three locations.

FIG. 3 illustrates a portion of one embodiment of a system supporting a videoconference session involving n locations, n being an integer greater than two.

FIG. 4 illustrates a portion of one embodiment of a system supporting a videoconference session involving two locations, where there is more than one participant at a remote location.

FIG. 5 illustrates a portion of one embodiment of a system supporting a videoconference session involving three locations, where there is more than one participant at each remote location.

FIG. 6 illustrates an example computing environment in which a distribution logic may operate.

FIG. 7 illustrates an example method associated with distributing audio associated with a videoconference.

FIG. 8 illustrates an example method associated with distributing audio associated with a videoconference.

FIG. 9 illustrates one embodiment of a videoconferencing location.

### DETAILED DESCRIPTION

Example systems, methods, and media described herein relate to localizing a videoconference participant voice with their displayed image. This facilitates identifying who is speaking during a videoconference where there are multiple remote locations and/or multiple participants. In one example, systems and methods may provide for audio orientation and separation that facilitate attributing audio output from a participant(s) at a first remote location to video output associated with the first remote location and attributing audio output from a participant(s) at a second remote location to video output associated with the second remote location. For example, video from the first location may be displayed on a first monitor and video from the second location may be displayed on a second monitor. In this example, audio from the first location would be localized to the first monitor and audio from the second location would be localized to the second monitor. In another example, video from both the first location and second location may be displayed in a blended image (e.g., split-screen) on a single display. In this example, audio from the first location would be localized to the portion of the display associated with video from the first location and audio from the second location would be localized to the portion of the display associated with video from the second location. While two remote locations are described, it is to be appreciated that a greater number of remote locations may be involved.

Localizing the voice of a videoconference participant with their displayed image may provide for audio orientation and separation that facilitate attributing audio output from a first participant at a remote location to video output associated with the first participant and attributing audio output from a second participant to video output associated with the second remote participant. The two participants may be located at the same remote location (e.g., in the same videoconference room) yet audio separation may still be available. For example, two participants may be seated on opposite sides of a table, may each have their own dedicated microphone, and so on. Rather than is typical in conventional systems, where a single output device may provide audio output for both of the two remote participants, and thus provide no sense of spatial separation between them, example systems may control local output devices to orient and separate audio signals associated with the two remote participants to create the impression of spatial separation between them in the local location, even though they are at a single remote location and displayed on a single monitor.

Thus, example systems facilitate making a videoconference more like an actual in-person conference since audio may be attributed on a first level to different remote locations whose video is displayed and in some cases audio may even be attributed on a second finer level to different participants within a single remote location.

To support this audio separation and orientation, a videoconference room from which audio and video may be acquired may be designed with a set of microphones and/or with a directional microphone(s). In one example, the set of microphones and/or directional microphone may be arranged in a manner that facilitates determining a spatial position (e.g., (x,y), (x,y,z) ) for a participant. For example, the set of microphones may ring a room, may be arranged in a grid in a room, may be localized to different seating positions at a conference table, may be localized to different speaking podiums in a room, and so on. This spatial position may be used to control filtering of audio received by the set of microphones. For example, only the input received from the microphone closest to the spatial position determined for the participant may be retained. Alternatively, and/or additionally, the spatial information may be provided along with audio data so that a receiving logic can selectively route the audio information to audio output devices that will facilitate providing spatial audio separation between participants.

In another example, the set of microphones and/or directional microphone(s) may be operably connected to a discriminating logic that determines from which microphone or location a cleanest signal (e.g., best signal to noise ratio), clearest signal, and/or loudest signal is being received. The discriminating logic may then control filtering of audio received by the set of microphones. Additionally, and/or alternatively, the spatial position and/or discriminating logic may be used to encode spatial information into an audio signal provided from the remote location. For example, rather than filter audio data, audio data may be annotated with information related to the different microphones. For example, volume data for a single audio sample received at each of the set of microphones may be encoded along with audio data. In one example, each participant may have a dedicated microphone that is associated with a determined location in the remote videoconference room. In this example, the microphone identifier may be provided along with the audio data.

In yet another example, multiple audio channels may be provided from a remote location. Thus, rather than filtering or annotating audio data at the remote location, filtering and/or distribution may occur at a receiving location. For example, a first set of audio channels may be routed to a first output device(s) at the receiving location and a second set of audio channels may be routed to a second output device(s) at the receiving location. In one example, relationships between audio sources and output devices may be hardwired. While inflexible, this configuration removes switching delays and may be appropriate for permanent conferencing situations. In another example, relationships between audio sources and output devices may be dynamically formed, reformed, and broken down. While more flexible, this may add switching overhead, setup overhead, tear down overhead, configuration overhead, and so on.

In another example, a single audio feed may be provided from each of several remote locations. Once again, audio from a first source may be associated with a first output device(s) at the receiving location and audio from a second source may be associated with a second output device(s) at the receiving location. The output devices may be chosen to make the audio appear to emanate from a screen or screen portion on which video associated with the appropriate remote location is being displayed. In this way, a participant's voice may appear to come from the screen or screen portion where the participant's face is presented. In one example, the routing relationships may be dynamically formed, reformed, broken down, and so on.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer-readable medium”, as used herein, refers to a medium that participates in directly or indirectly providing signals, instructions and/or data. A computer-readable medium may take forms, including, but not limited to, non-volatile media and volatile media. Non-volatile media may include, for example, optical or magnetic disks and so on. Volatile media may include, for example, semiconductor memories, dynamic memory and so on. Common forms of a computer-readable medium include, but are not limited to, a floppy disk, a hard disk, a magnetic tape, other magnetic medium, a CD-ROM, other optical medium, a RAM (random access memory), a ROM (read only memory), an EPROM, a FLASH-EPROM, or other memory chip or card, a memory stick, a carrier wave/pulse, and other media from which a computer, a processor or other electronic device can read.

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic (e.g., application specific integrated circuit (ASIC)), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities are considered to be operably connected if they are able to communicate signals to each other directly or through one or more intermediate entities like a processor, an operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms including routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may depend, for example, on requirements of a desired application, the environment in which it runs, the desires of a designer and/or programmer, and so on.

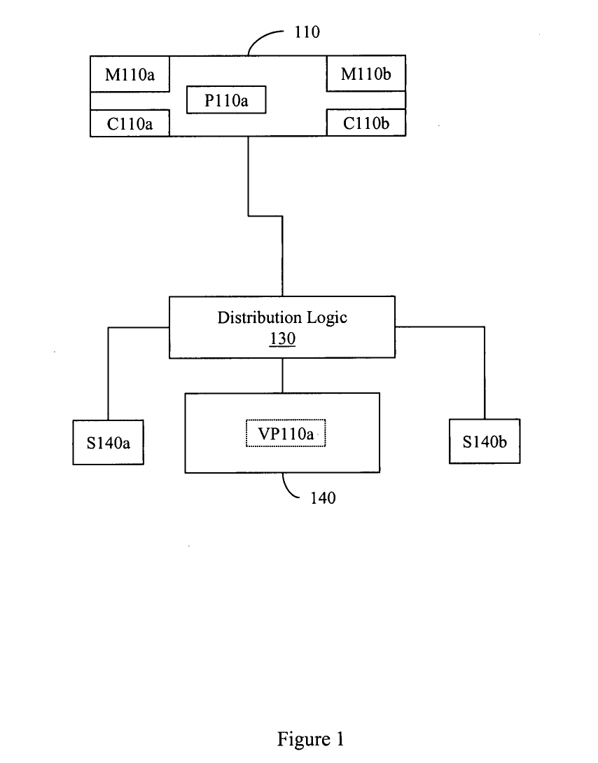

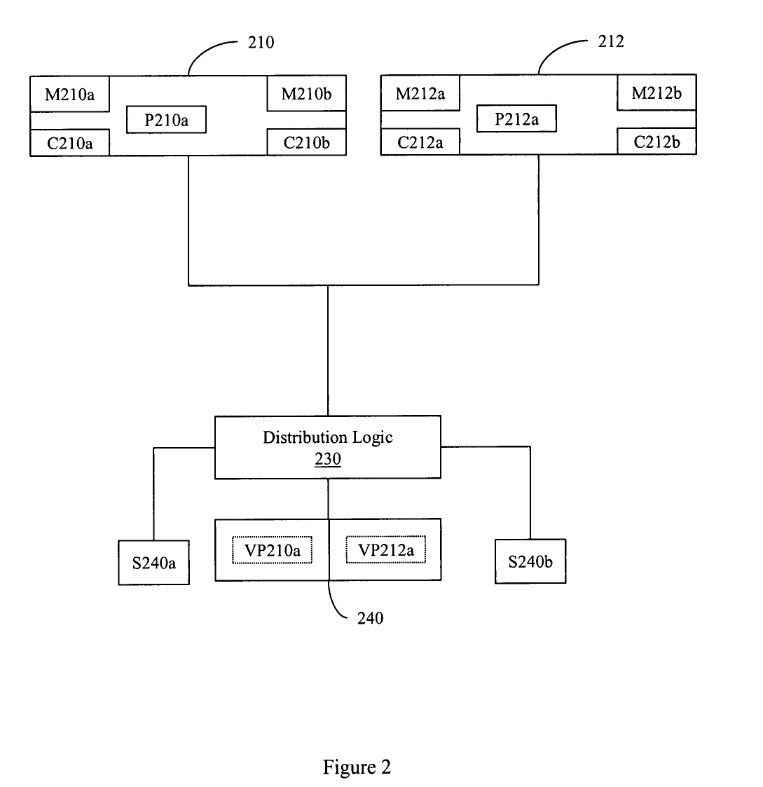

Turning now to FIG. 1, portions of a videoconferencing system are illustrated. The system may include a distribution logic 130 that can receive video data and audio data from remote videoconferencing sources. In FIG. 1, a single remote videoconferencing source 110 is illustrated. This single remote source 110 is configured with a set of microphones (e.g., M110a, M110b) and a set of cameras (e.g., C110a, C110b) through which audio and video input may be received from a participant P110a. Participants may be referred to as “talkers”. In FIG. 1, a single participant P110a is illustrated. While two microphones and two cameras are illustrated, it is to be appreciated that a greater and/or lesser number of input devices may be employed. Similarly, different combinations of input devices may be employed. While a single participant is illustrated, it is to be appreciated that more than one participant may be involved in a videoconference. Additionally, while a single remote videoconferencing source is illustrated, it is to be appreciated that a greater number of sources may exist. Examples of these combinations are illustrated in FIGS. 2 through 5.

Distribution logic 130 may be operably connected to a video output device(s) 140 and to an audio output device(s) (e.g., S140a, S140b). The video output device(s) 140 can display video data received from the remote videoconferencing source 110 and the audio output device(s) S140a-b can output audio data received from the remote videoconferencing source 110. Video output device 140 may be, for example, a monitor, a television, a projection device, and so on. Audio output devices S140a-b may be, for example, speakers. While a single video output device 140 and two audio output devices S140a-b are illustrated, it is to be appreciated that a greater number of output devices may be provided. In one example where there are multiple video output devices 140, the video output devices 140 may be separately controllable, may accept separate video inputs, and may present separate video outputs. Similarly, the audio output devices S140a-b may be separately controllable, may be able to accept separate audio inputs, and may able to produce separate audio outputs.

Combinations of audio and video may be presented in manners that facilitate creating the impression that audio is coming from or related to a video source. The impression may be created simultaneously for multiple remote videoconferencing locations. For example, a first remote location may be displayed on the left side of a split screen and voices of talkers at that first remote location may be made to appear to emanate from the left side of the split screen. Similarly, a second remote location may be displayed on the right side of a split screen and voices of talkers at that second remote location may be made to appear to emanate from the right side of the split screen. This may mitigate issues associated with conventional videoconferencing systems where no such attribution and separation is provided.

To create the attribution and separation, the distribution logic 130 can selectively route a portion of the audio data to a selected audio output device(s) and can selectively route a portion of the video data to a selected video display device(s). The routing may be based, for example, on a relationship between an audio source and a video source. For example, the audio may be attributable to a participant whose image is captured on camera. The goal of the routing is to cause audio outputs to be acoustically associated with related video outputs and to be acoustically spatially separate from other audio outputs. For example, if there are two video sources and two audio sources, the distribution logic 130 would be tasked with acoustically associating a first audio output with a first video output and with associating a second audio output with a second video output. But simply associating the audio with the video does not go far enough. Distribution logic 130 is tasked with distributing the audio data and the video data so that the different audio outputs are spatially distinguishable. By coordinating the distribution of audio and video, voices associated with talkers at a first location can appear to come from the video device where the video of the first talkers is presented and voices associated with talkers at a second location can appear to come from the video device where the video of the second talkers is presented. Also, the voices from the first talkers can come from a first identifiable location (e.g., left side of local location) while the voices from the second talkers can come from a second identifiable location (e.g., right side of room).

Distribution logic 130 may receive the audio data across different combinations of wiring, hardware, software, and transmission media. In one example, the audio data may be received over N connections, N being an integer greater than or equal to the number of audio sources. The N connections may include, for example, a circuit-switched connection, and a packet-switched connection. With N input audio channels available, distribution logic 130 may establish a path from one or more of the N connections to various audio output devices to create the spatial separation between audio output and to create the relationship of audio to video. These paths may be established during videoconferencing setup and thus little or no switching overhead may be incurred during the actual videoconference. This may mitigate delay issues associated with conventional multi-location videoconferencing systems.

In another example, the audio data may be received over M connections, M being an integer less than the number of audio sources. In this example, the audio data may include two or more audio signals that are multiplexed together. The multiplexing may be, for example, time division multiplexing (TDM), frequency division multiplexing (FDM), and so on. The M connections may include, for example, a circuit-switched connection, and a packet-switched connection. In this example, the distribution logic 130 may also establish a path(s) from one or more of the M connections to various audio output devices to create the relationship of audio to video. In yet another example, the audio data may be received over a single connection. Thus, the audio data may include two or more audio signals multiplexed together. The single connection may be a circuit switched connection, a packet-switched connection, and so on.

The distribution logic 130 may be embodied in different forms. For example, the distribution logic 130 may be embodied as a circuit. In one example, the circuit may be a dynamically configurable circuit. The configuration may be carried out, for example, by a computer, a logic, and so on. In another example, distribution logic 130 may be a computing component.

Distribution logic 130 may employ various techniques to determine how to route audio and/or video data. In one example, the routing may depend on spatial information associated with the audio data. The spatial information may, for example, identify an audio source location and identify a video source location related to the audio source location. For example, the spatial information may describe the x,y,z position of a talker and therefore image analysis software can determine which participant in a room is the talker based on the x,y,z coordinates. In another example, the spatial information may simply identify from which of several remote videoconferencing locations an audio signal originated. In yet another example, the spatial information may identify a particular microphone used at a remote videoconferencing location. These identifiers may then be used to route audio data to a set of output devices that will both relate the audio output to a corresponding video output and distinguish audio from different locations.

The audio data may also include other information upon which the distribution logic 130 can base decisions. For example, the audio data may include volume information that relates at least a portion of the audio data to a microphone and/or signal to noise ratio (SNR) information that relates at least a portion of the audio data to a microphone. When the distribution logic 130 has information about microphone locations and/or sound properties associated with different microphones, then distribution logic 130 can base routing decisions on the volume and/or SNR information.

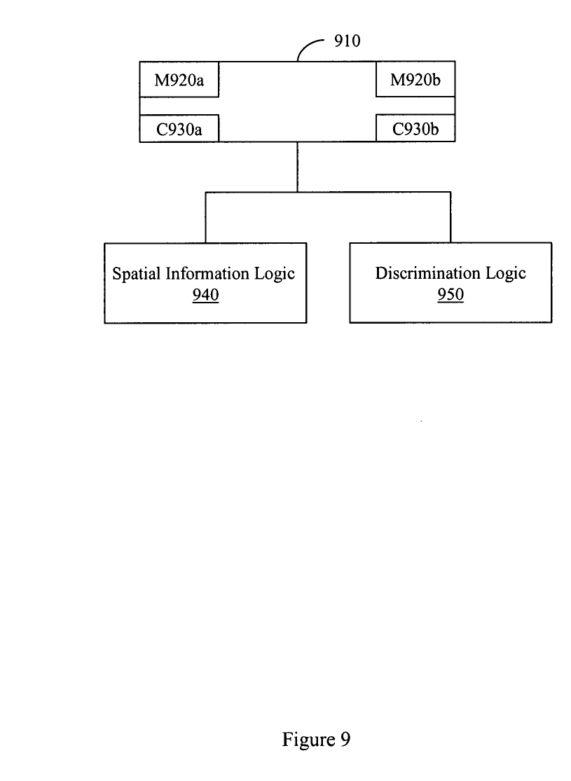

The spatial information associated with the audio data may be produced, for example, by a spatial information logic(s) 940 (FIG. 9) located at a remote videoconferencing source 910. Remote videoconferencing source 910 may include microphones (e.g., M920a-b) and cameras (e.g., C930a-b). A spatial information logic 940 may process input audio signals to determine spatial information associated with the audio signals. Thus, the remote videoconferencing source 910 may provide the spatial information with the audio data provided to the distribution logic 130. In one example, the spatial information logic 940 may provide spatial information sufficient to establish a one to one relationship between an audio source and a video source. This spatial information may include, for example, Cartesian coordinates of a speaker in a remote videoconferencing location, polar coordinates of a speaker in a remote videoconferencing location, an identifier of a microphone at a remote videoconferencing location, and so on. The spatial information logic 940 may make spatial determinations based, at least in part, on information received from discrimination logic 950. The discrimination logic 950 may determine from which microphone(s) a cleanest (e.g., best signal to noise ratio) signal was received, from which microphone(s) a clearest signal was received, from which microphone(s) a loudest signal was received, and so on. The discrimination logic 950 may then control filtering of audio received by the set of microphones.

As mentioned above, a local videoconferencing studio may interact with different combinations of remote videoconferencing studios having different combinations of remote videoconferencing participants. For example, FIG. 2 illustrates a distribution logic 230 operably connected to speakers S240a and S240b and to display 240 on which appear representations VP210a and VP212a which correspond respectively to participants P210a and P212a at remote videoconferencing locations 210 and 212. The remote videoconferencing locations include a set of microphones (e.g., M210a-M210b, M212a-M212b) and a set of cameras (e.g., C210a-210b, C212a-212b). While a single display 240 is illustrated, it is to be appreciated that display 240 may be embodied as a set of displays.

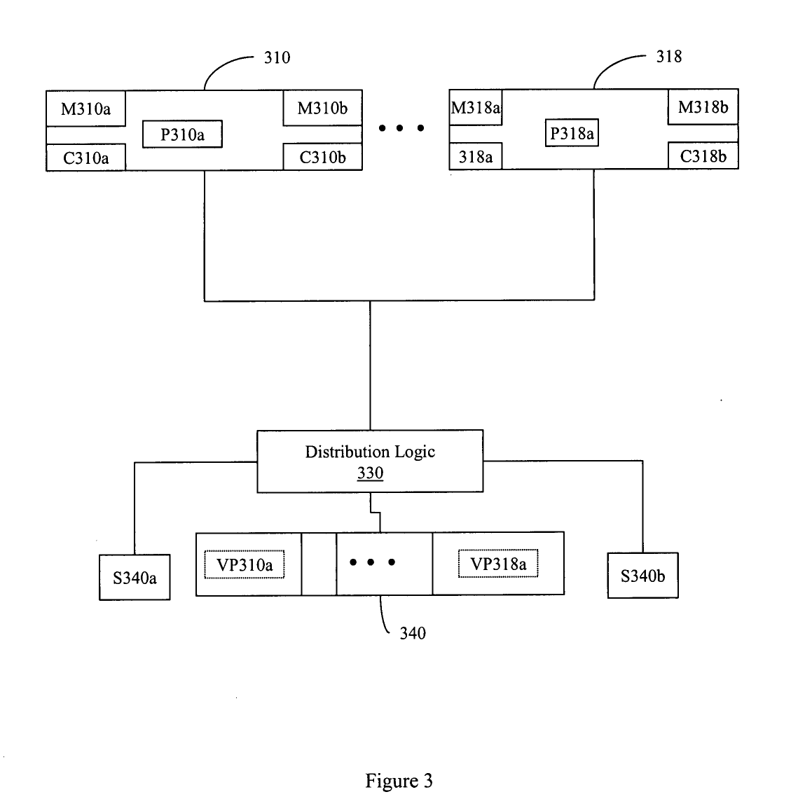

FIG. 3 illustrates a distribution logic 330 operably connected to speakers S340a and S340b and to display 340 on which appear representations VP310a through VP318a which correspond respectively to participants P310a through P318a at remote videoconferencing locations 310 through 318. The remote videoconferencing locations include a set of microphones (e.g., M310a-M310b, M318a-M318b) and a set of cameras (e.g., C310a-310b, C318a-318b). While a single display 340 is illustrated, it is to be appreciated that display 340 may be embodied as a set of displays.

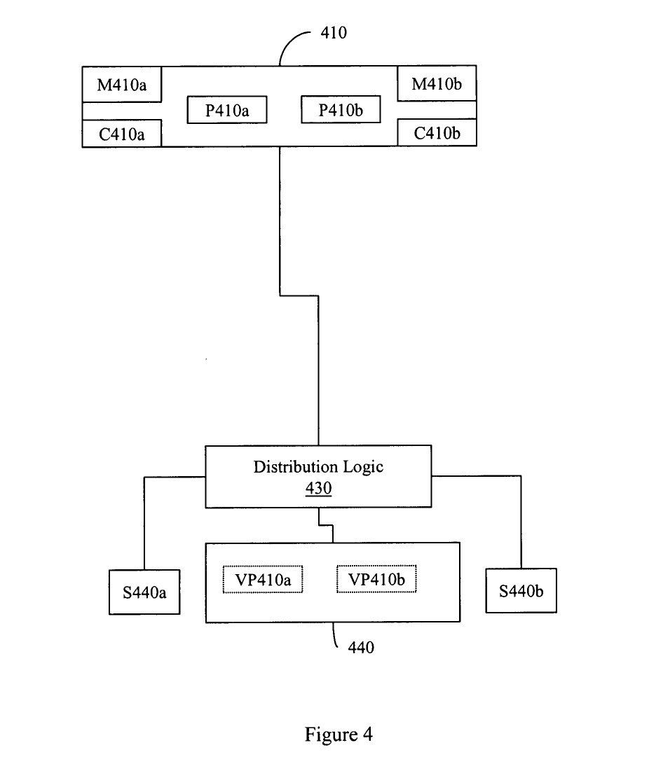

FIG. 4 illustrates a distribution logic 430 operably connected to speakers S440a and S440b and to display 440 on which appear representations VP410a and VP410b which correspond respectively to participants P410a and P410b at remote videoconferencing location 410. The single remote videoconferencing location includes a set of microphones (e.g., M410a-M410b) and a set of cameras (e.g., C410a-410b). Once again, while a single display 440 is illustrated, it is to be appreciated that display 440 may be embodied as a set of displays.

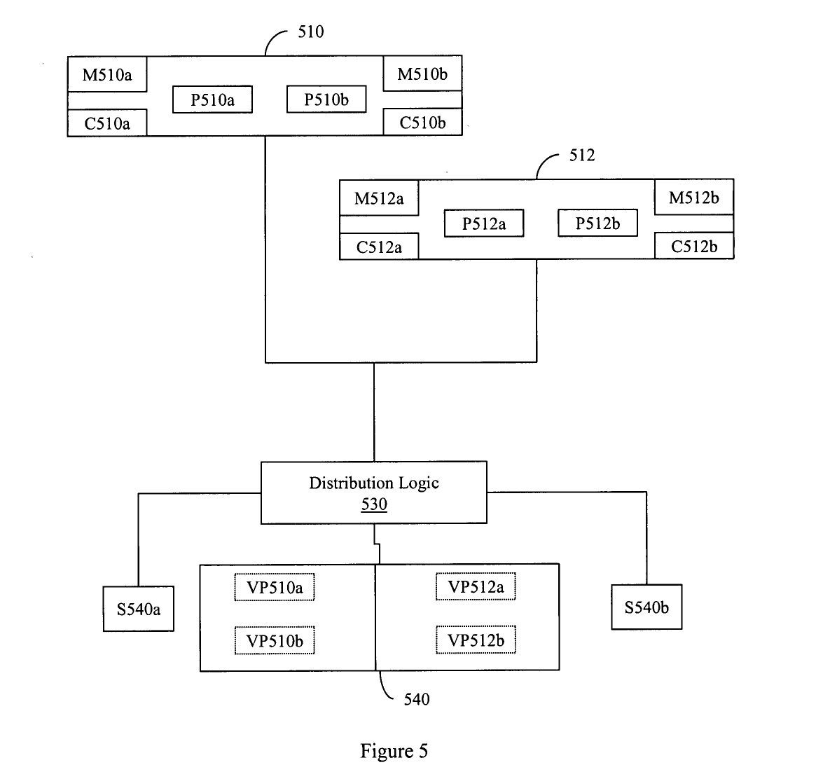

FIG. 5 illustrates a distribution logic 530 operably connected to speakers S540a and S540b and to display 540 on which appear representations VP510a, VP510b, VP512a, and VP512b which correspond respectively to participants P510a, P510b, P512a, and P512b at remote videoconferencing locations 510 and 512. The remote videoconferencing locations include a set of microphones (e.g., M510a-M510b, M512a-M512b) and a set of cameras (e.g., C510a-510b, C512a-512b). While a single display 540 is illustrated, it is to be appreciated that display 540 may be embodied as a set of displays.

In each of FIGS. 2 through 5, a distribution logic can receive the audio and video data and determine how to distribute both the audio data and the video data to create a single videoconference experience that may include portions that appear at the same time part of a larger whole and yet separate and distinct portions of that larger whole. This illusion is created by selecting audio and video devices or portions thereof through which output is provided. The illusion may also be created by controlling the audio and video devices or portions thereof based on spatial information available in the received data. In one example, the distribution and/or control may be computer based.

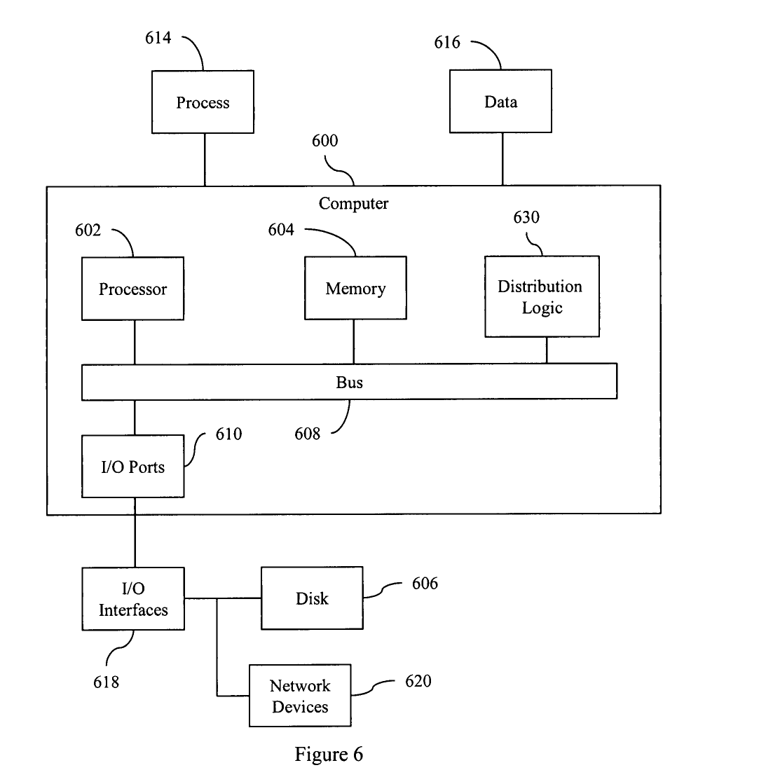

Thus, FIG. 6 illustrates an example computing device in which example systems and methods described herein, and equivalents, can operate. The example computing device may be a computer 600 that includes a processor 602, a memory 604, and input/output controllers 640 operably connected by a bus 608. In one example, the computer 600 may include a distribution logic 630 configured to facilitate providing separation to facilitate attributing designated audio to designated video in a videoconference environment. Thus, in one example, distribution logic 630 may provide means (e.g., hardware, software, firmware, circuitry) for receiving videoconferencing data from multiple sources where the videoconferencing data includes both audio data and video data. Distribution logic 630 may also include means (e.g., hardware, software, firmware, circuitry) for determining how to present a local presentation of a videoconference involving multiple sources so that the multiple sources appear visually and acoustically distinct in the local presentation. Distribution logic 630 may also include means (e.g., hardware, software, firmware, circuitry) for presenting the local presentation of the videoconference involving multiple sources so that the multiple sources appear visually and acoustically distinct. While distribution logic 630 is illustrated as a hardware component attached to bus 608, it is to be appreciated that in one example, distribution logic 630 could be implemented in software, stored on disk 606, brought into memory 604, and executed by processor 602.

Generally describing an example configuration of computer 600, processor 602 can be a variety of various processors including dual microprocessor and other multi-processor architectures. Memory 604 can include volatile memory (e.g., RAM) and/or non-volatile memory (e.g., ROM).

A disk 606 may be operably connected to computer 600 via, for example, an input/output interface (e.g., card, device) 618 and an input/output port 610. Disk 606 may include, for example, a magnetic disk drive, a solid state disk drive, a floppy disk drive, a tape drive, a Zip drive, a flash memory card, and/or a memory stick. Furthermore, disk 606 may include optical drives (e.g., a CD-ROM), a CD recordable drive (CD-R drive), a CD rewriteable drive (CD-RW drive), and/or a digital video ROM drive (DVD ROM). Memory 604 can store processes 614 and/or data 616, for example. Disk 606 and/or memory 604 can store an operating system that controls and allocates resources of computer 600.

Bus 608 may be a single internal bus interconnect architecture and/or other bus or mesh architectures. While a single bus is illustrated, it is to be appreciated that computer 600 may communicate with various devices, logics, and peripherals using other busses that are not illustrated (e.g., PCIE, SATA, Infiniband, 1394, USB, Ethernet). Bus 608 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

Computer 600 may interact with input/output devices via i/o interfaces 618 and input/output ports 610. Input/output devices can include, but are not limited to, a keyboard, a microphone, a pointing and selection device, cameras, video cards, displays, disk 606, network devices 620, and so on. Input/output ports 610 may include but are not limited to, serial ports, parallel ports, and USB ports.

Computer 600 may operate in a network environment and thus may be connected to network devices 620 via i/o devices 618, and/or i/o ports 610. Through network devices 620, computer 600 may interact with a network through which computer 600 may be logically connected to remote computers. The networks with which computer 600 may interact include, but are not limited to, a local area network (LAN), a wide area network (WAN), and other networks. Network devices 620 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and so on. Similarly, network devices 620 can connect to WAN technologies including, but not limited to, point to point links, circuit switching networks like integrated services digital networks (ISDN), packet switching networks, and digital subscriber lines (DSL).

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and so on. It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, calculating, determining, displaying, and so on, refer to actions and processes of a computer system, logic, processor, or similar electronic device that manipulates and transforms data represented as physical (electronic) quantities.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various actions occurring in serial, it is to be appreciated that in different examples, various actions could occur concurrently, substantially in parallel, and/or at substantially different points in time.

Example methods described and illustrated herein may be implemented as processor executable instructions and/or operations stored on a computer-readable medium. Thus, a computer-readable medium may store processor executable instructions operable to perform method 700. While method 700 is described being stored on a computer-readable medium, it is to be appreciated that other example methods (e.g., 800) described herein can also be stored on a computer-readable medium.

Method 700 may include, at 710, receiving an audio signal from a set of remote videoconferencing audio sources. In different examples, the audio sources may be located at a single remote videoconferencing location (e.g., studio) and/or may be associated with different remote videoconferencing locations (e.g., studios). In one example, receiving the audio signal includes receiving electronic signals corresponding to audible data detected at a remote videoconferencing audio source. Receiving the audio signal may also include receiving electronic signals that characterize the remote videoconferencing audio source. The characterizing signals may include, for example, an audio source identifier, and a participant identifier. The identifiers may be, for example, data values, signals, and so on. The identifiers may facilitate correlating and audio source and a video source and thus may facilitate separating audio outputs at a receiving location.

Method 700 may also include, at 720, receiving a video signal from a set of remote videoconferencing video sources related to the set of remote videoconferencing audio sources. In one example, receiving the video signal may include receiving electronic signals corresponding to visual data detected at a remote videoconferencing video source. This visual data may be, for example, images of a talker captured by a camera. Receiving the video signal may also include receiving electronic signals that characterize the remote videoconferencing video source. The electronic signals may include, for example, a video source identifier, and a participant identifier. The identifiers may be, for example, values for data items, signals, and so on. These identifiers, together with the audio data identifiers, can be used, for example, by a distribution logic to determine how to distribute signals to create the impressions of separated audio-visual presentations.

Method 700 may also include, at 730, determining how to distribute the audio signal to a set of audio speakers and determining how to distribute the video signal to a set of video displays. In one example, determining how to distribute the audio signal and the video signal may include identifying a subset of collectively controllable output devices capable of producing an integrated audio-visual presentation. The composition of the subset may depend, for example, on the number of participants, the number of remote locations, the number of output devices available at the local location, and so on.

Method 700 may also include, at 740, distributing a first portion of the video signal to a first subset of the set of video displays. In the case of a single video display, the “subset” of video displays may be logically created by partitioning the screen real estate available on the single video display. The distributing at 740 may also include distributing a first portion of the audio signal related to the first portion of the video signal. The first portion of the audio signal may be distributed to a first subset of audio devices. In the case of a single audio output device (e.g., speaker), the “subset” of audio devices may be logically created by modifying different sets of sounds to have different characteristics. For example, volume, modulation, mix (e.g., treble, bass, midrange), reverb, and so on may be manipulated to create the impression of two different audio devices. The subsets of audio output devices and video output devices are selected to create a first audio-visual presentation having the first portion of the video signal spatially correlated to the first portion of the audio signal. In one example, distributing the first portion of the video signal and the related first portion of the audio signal includes providing the video, providing the related audio, and providing a control signal to synchronize the output of the video and the related audio.

Method 700 may also include, at 750, distributing a second portion of the video signal to a second subset of video displays and distributing a second portion of the audio signal related to the second portion of the video signal to a second subset of audio output devices. Once again, the second subset may be a physical or logical subset selected and/or controlled to facilitate creating the impression of different audio and/or video devices.

The subsets of output devices determined at 730 are provided with audio and video data at 740 and 750 to create a audio-visual presentations having their video signals spatially correlated to their audio signals. The subsets are selected and/or controlled to make a first audio-visual presentation identifiably separate from a second (or Nth) audio-visual presentation. Being identifiably separate includes being spatially distinguishable and acoustically distinguishable.

Thus, providing the first portions at 740 and providing the second portions at 750 may involve controlling sets of collectively and individually controllable output devices to present simultaneously a plurality of integrated audio-visual presentations so that members of the plurality of integrated audio-visual presentations are individually identifiable, both visually and acoustically, from other member of the plurality of integrated audio-visual presentations.

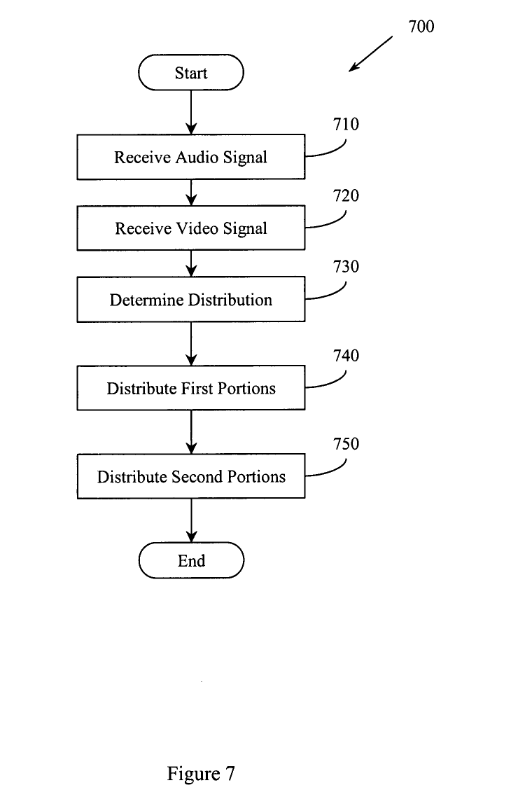

FIG. 7 illustrates an example method 700. The illustrated elements denote “processing blocks” that may be implemented in logic. In one example, the processing blocks may represent executable instructions that cause a computer, processor, and/or logic device to respond, to perform an action(s), to change states, and/or to make decisions. Thus, described methods may be implemented as processor executable instructions and/or operations provided by a computer-readable medium. In another example, processing blocks may represent functions and/or actions performed by functionally equivalent circuits like an analog circuit, a digital signal processor circuit, an application specific integrated circuit (ASIC), or other logic device.

While FIG. 7 illustrates various actions occurring in serial, it is to be appreciated that various actions illustrated in FIG. 7 could occur substantially in parallel. By way of illustration, a first process could receive audio signals and video signals. Similarly, a second process could determine distributions, while a third process could provide the portions of audio data and/or video data associated with the determinations. While three processes are described, it is to be appreciated that a greater and/or lesser number of processes could be employed and that lightweight processes, regular processes, threads, and other approaches could be employed.

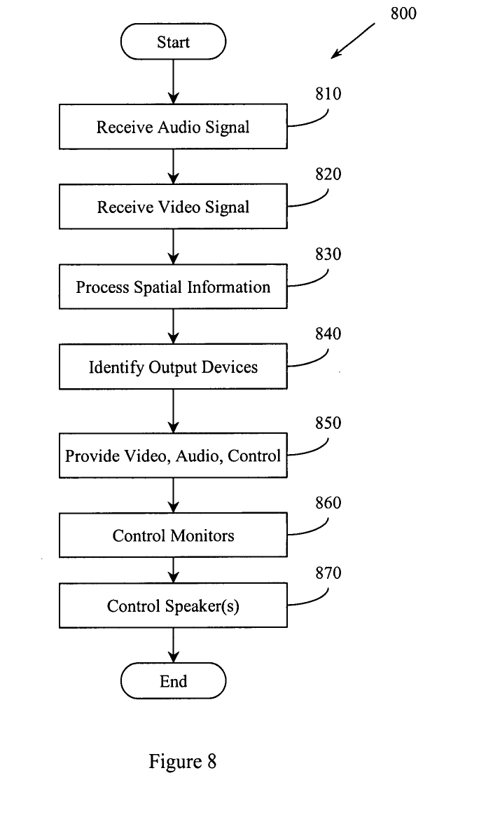

FIG. 8 illustrates a method 800 that includes some actions similar to those described in connection with method 700 (FIG. 7). For example, method 800 includes receiving 810 an audio signal and receiving 820 a video signal. Method 800 may also include, at 830, processing spatial information available in the audio and/or video signals. Processing the spatial information may include resolving correlations between identifiers, performing image analysis, and so on.

Method 800 may also include, at 840, identifying output devices available to create audio-visual presentations and then subdividing the output devices, either logically and/or physically, to create subsets of devices on which acoustically spatially separated presentations can be provided. With the subsets identified, method 800 may proceed, at 850, to provide audio, video, and control information to devices. Method 800 may then control monitors at 860 and speakers at 870 to simultaneously present separate portions of a larger videoconference. Controlling the monitors and speakers may include, for example, controlling when output is to be provided, controlling how output is to provided, controlling which competing outputs are to be provided, and so on.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A system, comprising:
a distribution logic to receive from two or more remote videoconferencing sources a video data and an audio data;
one or more video display devices to display the video data, the video display devices being separately controllable, being able to accept separate video inputs, and being able to present separate video outputs; and
two or more audio output devices to output the audio data, the audio output devices being separately controllable, being able to accept separate audio inputs, and being able to produce separate audio outputs,
the distribution logic to selectively route a portion of the audio data to an audio output device and to selectively route a portion of the video data to a video display device, the routing being based, at least in part, on a relationship between an audio source and a video source, the routing to cause a first audio output to be acoustically associated with a first video output and a second audio output to be acoustically associated with a second video output,
the first audio output and the second audio output being spatially distinguishable.

2. The system of claim 1, the audio data to be received over N connections, N being an integer greater than or equal to the number of audio sources, the N connections including one or more of, a circuit-switched connection, and a packet-switched connection.

3. The system of claim 2, the distribution logic to establish a path from a member of the N connections to an audio output device and to a video display device.

4. The system of claim 1, the audio data to be received over M connections, M being an integer less than the number of audio sources, the audio data comprising two or more audio signals multiplexed together, the M connections including one or more of, a circuit-switched connection, and a packet-switched connection.

5. The system of claim 4, the distribution logic to establish a path from a member of the M connections to an audio output device and to a video display device.

6. The system of claim 1, the audio data to be received over a single connection, the audio data comprising two or more audio signals multiplexed together, the single connection being one of, a circuit switched connection, and a packet-switched connection.

7. The system of claim 1, the distribution logic being one of, a circuit, a dynamically configurable circuit, a computer configurable circuit, and a computing component.

8. The system of claim 1, the audio data including spatial information to identify an audio source location and to identify a video source location related to the audio source location.

9. The system of claim 8, where the spatial information includes one or more of, a remote videoconferencing location identifier, an identifier of a position within a remote videoconferencing location, and an identifier of a microphone at a remote videoconferencing location with which a portion of the audio data is associated.

10. The system of claim 1, the distribution logic to selectively route the audio data based, at least in part, on one or more of, spatial information associated with at least a portion of the audio data, volume information that relates at least a portion of the audio data to a microphone, signal to noise information that relates at least a portion of the audio data to a microphone, and microphone identification information that relates at least a portion of the audio data to a microphone.

11. The system of claim 1, the audio data to be received from a remote system comprising:
one or more sets of microphones to receive audio signals from audio sources at remote videoconferencing locations; and
a spatial information logic to process the audio signals to determine spatial information associated with the audio signals and to provide the spatial information with the audio data provided to the distribution logic, the spatial information comprising one or more of, Cartesian coordinates, polar coordinates, and microphone identifiers,
the distribution logic to separate related audio signals based on the spatial information, the distribution logic to route based, at least in part, on the spatial information.

12. The system of claim 11, including a discrimination logic to determine from which microphone a cleanest signal was received, from which microphone a clearest signal was received, and from which microphone a loudest signal was received;
the spatial information logic to establish a one to one relationship between an audio source and a video source based, at least in part, on information provided by the discrimination logic.

13. A system, comprising:
a distribution logic to receive from two or more remote videoconferencing sources a video data and an audio data, the distribution logic being one of, a circuit, a dynamically configurable circuit, a computer configurable circuit, and a computing component, the audio data including spatial information to identify an audio source location and to identify a video source location related to the audio source location, the spatial information including one or more of, an identifier of a remote videoconferencing location, an identifier of a position within a remote videoconferencing location, and an identifier of a microphone at a remote videoconferencing location with which a portion of the audio data is associated;
the audio data to be received over M connections, M being an integer less than or equal to the number of audio sources, the audio data comprising two or more audio signals multiplexed together, the M connections including one or more of, a circuit-switched connection, and a packet-switched connection;
one or more video display devices to display the video data, the video display devices being separately controllable, being able to accept separate video inputs, and being able to present separate video outputs; and
two or more audio output devices to output the audio data, the audio output devices being separately controllable, being able to accept separate audio inputs, and being able to produce separate audio outputs,
the audio data to be received from a remote system comprising:
one or more sets of microphones to receive audio signals from audio sources at remote videoconferencing locations; and
a spatial information logic to process the audio signals to determine spatial information associated with the audio signals and to provide the spatial information with the audio data provided to the distribution logic, the spatial information logic to establish a one to one relationship between an audio source and a video source, the spatial information comprising one or more of, Cartesian coordinates, polar coordinates, and microphone identifiers,
the distribution logic to selectively route a portion of the audio data to an audio output device and to selectively route a portion of the video data to a video display device, the routing being based, at least in part, on a relationship between an audio source and a video source and on the spatial information,
the routing to cause a first audio output to be acoustically associated with a first video output and a second audio output to be acoustically associated with a second video output,
the video display devices and the audio output devices being arranged in a videoconferencing studio,
the first audio output and the second audio output being spatially distinguishable.

14. A computer-readable medium storing processor executable instructions that when executed by a processor cause the processor to perform a method, the method comprising:
receiving an audio signal from a set of remote videoconferencing audio sources;
receiving a video signal from a set of remote videoconferencing video sources related to the set of remote videoconferencing audio sources;
determining how to distribute the audio signal to a set of audio speakers;
determining how to distribute the video signal to a set of video displays;
distributing a first portion of the video signal to a first subset of the set of video displays;
distributing a first portion of the audio signal related to the first portion of the video signal to a first subset of the set of audio speakers to create a first audio-visual presentation where the first portion of the video signal is spatially correlated to the first portion of the audio signal;
distributing a second portion of the video signal to a second subset of the set of video displays; and
distributing a second portion of the audio signal related to the second portion of the video signal to a second subset of the set of audio speakers to create a second audio-visual presentation where the second portion of the video signal is spatially correlated to the second portion of the audio signal and where the first audio-visual presentation is identifiably separate from the second audio-visual presentation, where being identifiably separate includes being spatially distinguishable and acoustically distinguishable.

15. The computer-readable medium of claim 14, where receiving the audio signal includes receiving electronic signals corresponding to audible data detected at a remote videoconferencing audio source and receiving electronic signals that characterize the remote videoconferencing audio source including one or more of, an audio source identifier, and a participant identifier, and
where receiving the video signal includes receiving electronic signals corresponding to visual data detected at a remote videoconferencing video source and receiving electronic signals that characterize the remote videoconferencing video source including one or more of, a video source identifier, and a participant identifier.

16. The computer-readable medium of claim 15, where determining how to distribute the audio signal and the video signal includes identifying one or more subsets of collectively controllable output devices capable of producing an integrated audio-visual presentation.

17. The computer-readable medium of claim 16, where distributing the first portion of the video signal and the related first portion of the audio signal includes providing the first portion of the video signal, providing the related first portion of the audio signal, and providing a control signal to synchronize the output of the first portion of the video signal and the related first portion of the audio signal, and
where distributing the second portion of the video signal and the related second portion of the audio signal includes providing the second portion of the video signal, providing the related second portion of the audio signal, and providing a control signal to synchronize the output of the second portion of the video signal and the related second portion of the audio signal.

18. The computer-readable medium of claim 17, including controlling the set of collectively controllable output devices to present simultaneously a plurality of integrated audio-visual presentations, where a member of the plurality of integrated audio-visual presentations is individually identifiable both visually and acoustically from another member of the plurality of integrated audio-visual presentations.

19. A system, comprising:
means for receiving videoconferencing data from multiple sources, the videoconferencing data including both audio data and video data;
means for determining how to present a local presentation of a videoconference involving multiple sources so that the multiple sources appear visually and acoustically distinct in the local presentation; and
means for presenting the local presentation of the videoconference involving multiple sources so that the multiple sources appear visually and acoustically distinct.

20. The system of claim 19, including:
means for acquiring videoconferencing data at a remote videoconferencing location;
means for determining spatial data to relate audio data in the videoconferencing data to video data in the videoconferencing data;
means for determining separation data to separate a first audio source from a second audio source;
means for incorporating the spatial data and the separation data into the videoconferencing data; and
means for providing the videoconferencing data.
